(19) United States
(12) Patent Application Publication
(10) Pub. No.: US 2025/0192476 A1
(43) Pub. Date: Jun. 12, 2025

(54) ELECTRONIC DEVICE

(71) Applicant: Acer Incorporated, New Taipei City (TW)

(72) Inventors: Wei-Chih Wang, New Taipei City (TW); Chih-Wei Liao, New Taipei City (TW)

(73) Assignee: Acer Incorporated, New Taipei City (TW)

(21) Appl. No.: 18/767,977

(22) Filed: Jul. 9, 2024

(30) Foreign Application Priority Data
Dec. 8, 2023 (TW) 112147841

(51) Int. Cl. H01R 13/631; H01R 24/20

(52) U.S. Cl. CPC H01R 13/631; H01R 24/20

(57) ABSTRACT

An electronic device including a body, a female connector and two guiding members is provided. The body has a lateral opening, and the female connector and the two guiding members are disposed in the body as corresponding to the lateral opening. The male connector is adapted to be inserted into the lateral opening along a first direction and plugged into the female connector. The two guiding members are adapted to slide along a second direction perpendicular to the first direction, wherein each guiding member includes a guiding part located in the lateral opening, and the two guiding parts encircle to form a movable opening. When the male connector is inserted into the lateral opening, the male connector contacts the two guiding parts and pushes the two guiding parts to slide away from each other, and thus the movable opening expands from a first opening area to a second opening area.

### CROSS-REFERENCE TO RELATED APPLICATION

This application claims the priority benefit of Taiwan application serial no. 112147841, filed on Dec. 8, 2023. The entirety of the above-mentioned patent application is hereby incorporated by reference herein and made a part of this specification.

### BACKGROUND

### Technical Field

The disclosure relates to an electronic device, and in particular to an electronic device having a female connector.

### Description of Related Art

Electronic devices such as notebook computers, tablet computers, or smartphones are commonly provided with lateral openings at the lateral sides of the body, and female connectors are provided inside the body as corresponding to the lateral openings. Specifically, the male connector is adapted to be inserted into the side opening and plugged into the female connector to transmit power or signal. During the process of plugging the male connector into the female connector, the male connector which is misaligned with the female connector would easily collide with the female connector, causing damage to the female connector and greatly reducing the service life of the female connector.

### SUMMARY

The disclosure provides an electronic device that helps elongate the service life of a female connector.

According to an embodiment of the disclosure provides an electronic device suitable for connection with a male connector. The electronic device includes a body, a female connector and two guiding members. The body has a lateral opening, and the female connector and the two guiding members are disposed in the body as corresponding to the lateral opening. The male connector is adapted to be inserted into the lateral opening along a first direction and plugged into the female connector. The two guiding members are adapted to slide along a second direction perpendicular to the first direction, wherein each of the two guiding members includes a guiding part located in the lateral opening, and the two guiding parts encircle to form a movable opening. When the male connector is inserted into the lateral opening, the male connector contacts the two guiding parts and pushes the two guiding parts to slide away from each other, and thus the movable opening expands from a first opening area to a second opening area.

Based on the foregoing, in the electronic device of the disclosure, the body is integrated with a guiding design with buffering in the lateral opening. When the male connector is inserted into the lateral opening, not only the inserting speed and force of the male connector can be decreased due to the action of the guiding design with buffering, but also align the male connector with the female connector to smoothly plug into the female connector, and thus preventing the male connector from colliding with the female connector due to misalignment and helping to reduce the chance of damage to the female connector to elongate the service life thereof.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1A is a partial schematic diagram of an electronic device according to an embodiment of the disclosure and a male connector matched thereto.

FIG. 1B is a partial schematic diagram of the male connector of FIG. 1A being plugged into the female connector.

FIG. 2A and FIG. 2B are schematic front views of FIG. 1A and FIG. 1B respectively, and the male connector is omitted.

FIG. 3A and FIG. 3B are schematic diagrams of FIG. 1A and FIG. 1B from other perspectives respectively, and the male connector and the female connector are omitted.

### DESCRIPTION OF THE EMBODIMENTS

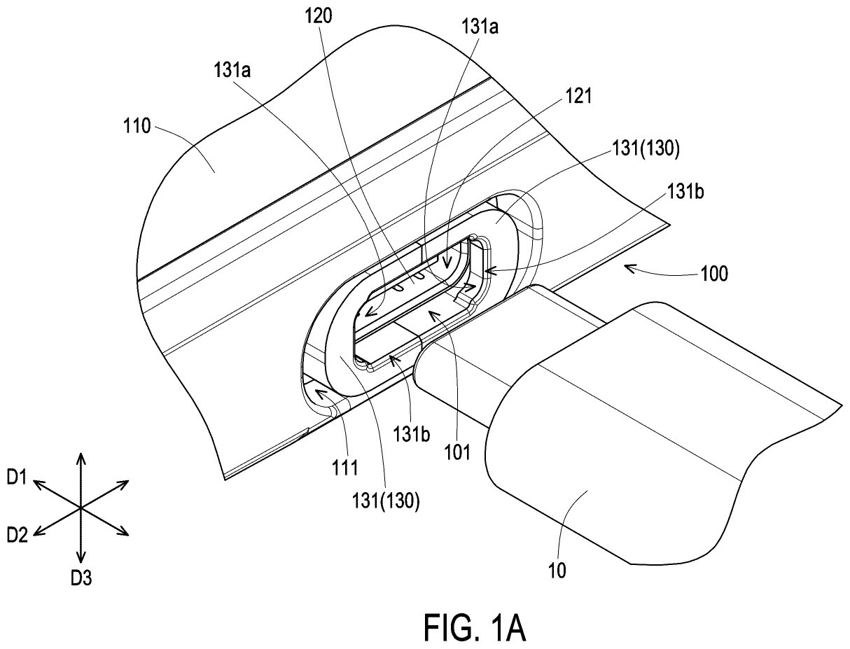

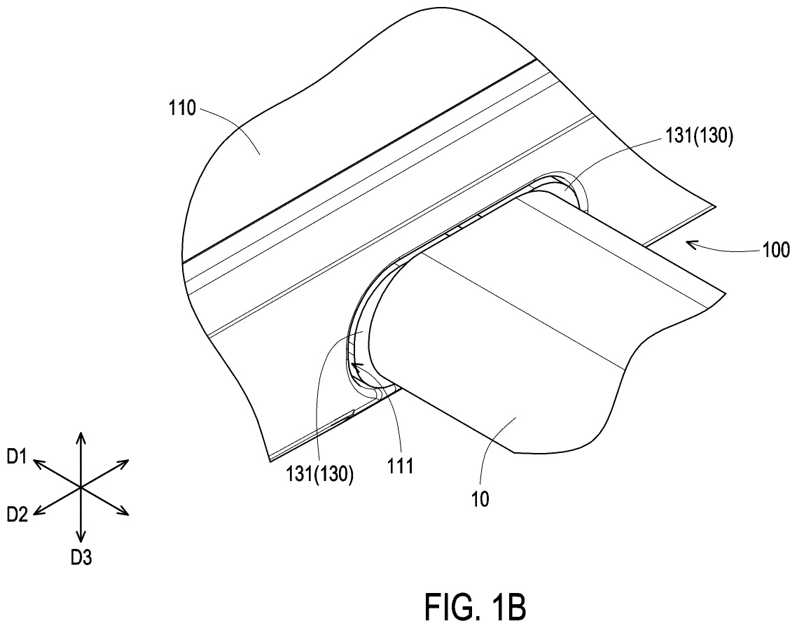

FIG. 1A is a partial schematic diagram of an electronic device according to an embodiment of the disclosure and a male connector matched thereto. FIG. 1B is a partial schematic diagram of the male connector of FIG. 1A being plugged into the female connector. Please refer to FIG. 1A and FIG. 1B, in the embodiment, the electronic device 100 may be a notebook computer, a tablet computer, or a smartphone, and includes a body 110, a female connector 120 and two guiding members 130 arranged in symmetry. In detail, the body 110 has a lateral opening 111, and the female connector 120 is disposed in the body 110 as corresponding to the lateral opening 111. The male connector 10 is adapted to be inserted into the lateral opening 111 along a first direction D1 and plugged into the female connector 120 to transmit power or signal.

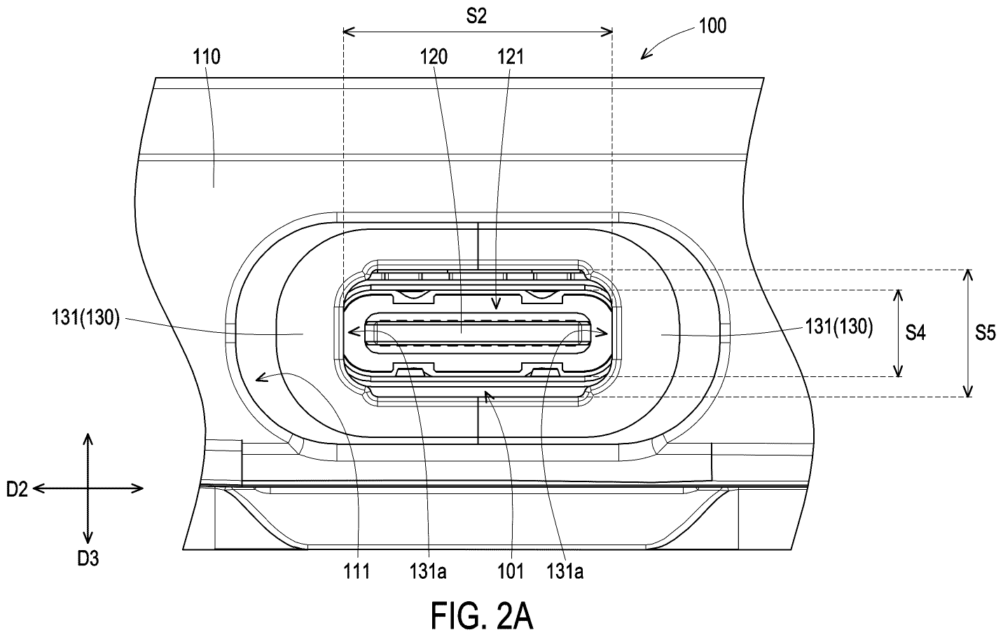

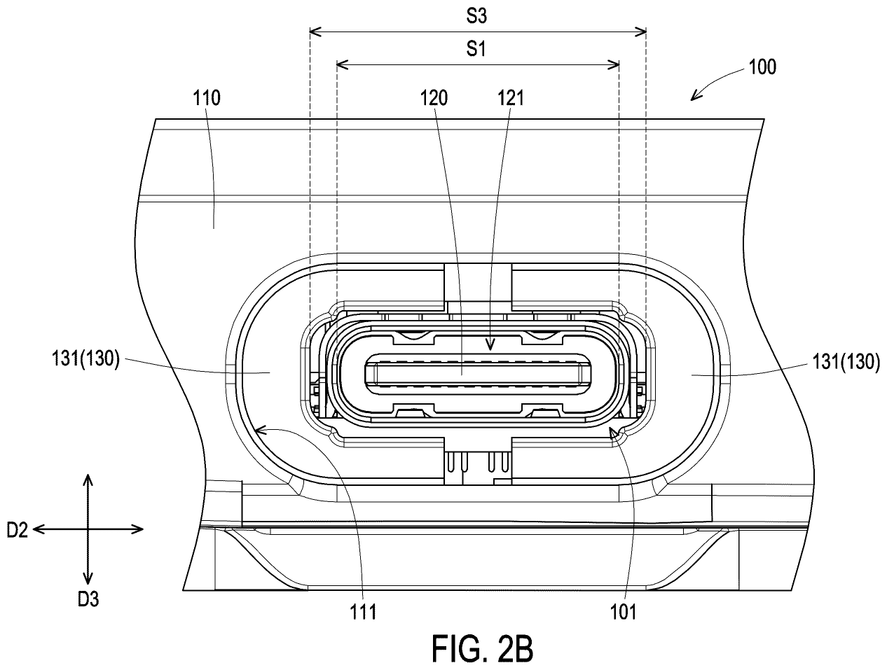

FIG. 2A and FIG. 2B are schematic front views of FIG. 1A and FIG. 1B respectively, and the male connector 10 is omitted. Please refer to FIG. 1A, FIG. 1B, FIG. 2A and FIG. 2B, the two guiding members 130 are served as a guiding design with buffering which is integrated into the lateral opening 111 of the body 110. When the male connector 10 is inserted into the lateral opening 111, not only the inserting speed and force of the male connector 10 can be decreased due to the action of the guiding design with buffering, but also align the male connector 10 with the female connector 120.

When the male connector 10 is inserted into the lateral opening 111, the male connector 10 contacts the two guiding member 130. In detail, the two guiding members 130 may apply actions of buffering and guiding to the male connector 10 moving toward the female connector 120, wherein the action of buffering means the inserting speed and force of the male connector 10 can be decreased by the two guiding member 130, and the action of guiding means the male connector 10 can be guided by the two guiding member 130 to align with the female connector 120. As such, the male connector 10 can be smoothly plugged into the female connector 120, and thus preventing the male connector 10 from colliding with the female connector 120 due to misalignment and helping to reduce the chance of damage to the female connector 120 to elongate the service life thereof.

As shown in FIG. 2A and FIG. 2B, in the embodiment, each of the two guiding members 130 includes a guiding part 131 located in the lateral opening 111, and the two guiding parts 131 encircle to form a movable opening 101. As shown in FIG. 1A and FIG. 2A, before the male connector 10 is inserted into the lateral opening 111, the two guiding parts 131 are in contact, and the movable opening 101 has a first opening area.

As shown in FIG. 1B and FIG. 2B, when the male connector 10 is inserted into the lateral opening 111 along the first direction D1, the male connector 10 contacts the two guiding parts 131 and pushes the two guiding parts 131 to slide away from each other along a second direction D2 perpendicular to the first direction D1, and thus the movable opening 101 expands from the first opening area to a second opening area. After the movable opening 101 is expanded to the second opening area, the male connector 10 can smoothly pass through the lateral opening 111 and the two guiding parts 131 and thus being accurately inserted into the female connector 120.

As shown in FIG. 2A and FIG. 2B, the female connector 120 has a connector opening 121 for the male connector 10 inserting thereto. In the second direction D2, the connector opening 121 has a first inner diameter S1. On the other hand, in the second direction D2, the movable opening 101 has a second inner diameter S2 smaller than the first inner diameter S1 when the two guiding parts 131 are in contact, and the movable opening 101 has a second inner diameter S2 greater than the first inner diameter S1 when the two guiding parts 131 are separated from each other.

For example, the male connector 10 has a connector housing adapted to be inserted into the connector opening 121. In the second direction D2, the outer diameter of the connector housing is slightly smaller than the first inner diameter S1 of the connector opening 121, but is slightly greater than the second inner diameter S2. When the two guiding parts 131 are in contact, the second inner diameter S2 of the movable opening 101 in the second direction D2 is smaller than the first inner diameter S1 and the outer diameter of the connector housing of the male connector 10. Based on the design, when the male connector 10 is inserted into the lateral opening 111, the male connector 10 can contact the two guiding parts 131, and the two guiding parts 131 apply the actions of buffering and guiding to the male connector 10.

As shown in FIG. 1A, FIG. 2A and FIG. 2B, in a third direction D3 perpendicular to the first direction D1 and the second direction D2, the connector opening 121 has a fourth inner diameter S4, and the movable opening 101 has a fifth inner diameter S5 greater than the fourth direction S4. Furthermore, the fifth inner diameter S5 of the movable opening 101 in the third direction D3 is fixed, while the movable opening 101 can be expanded from the first inner diameter S1 to the third inner diameter S3 or decreased from the third inner diameter S3 to the first inner diameter S1 in the second direction D2. That is to say, the change in the opening area of the movable opening 101 is mainly determined by the change in the inner diameter of the movable opening 101 in the second direction D2.

Please refer to FIG. 1A, FIG. 1B, FIG. 2A and FIG. 2B, in the embodiment, each of the two guiding parts 131 has a recessed opening 131a, and the two recessed openings 131a face each other to define the movable opening 101. On the other hand, each of the two guiding parts 131 further has a guiding bevel 131b surrounding the recessed opening 131a. When the male connector 10 is inserted into the lateral opening 111, the guiding bevel 131b of each of the two guiding parts 131 can apply actions of guiding and aligning to the male connector 10, so that the male connector 10 is aligned with the female connector 120.

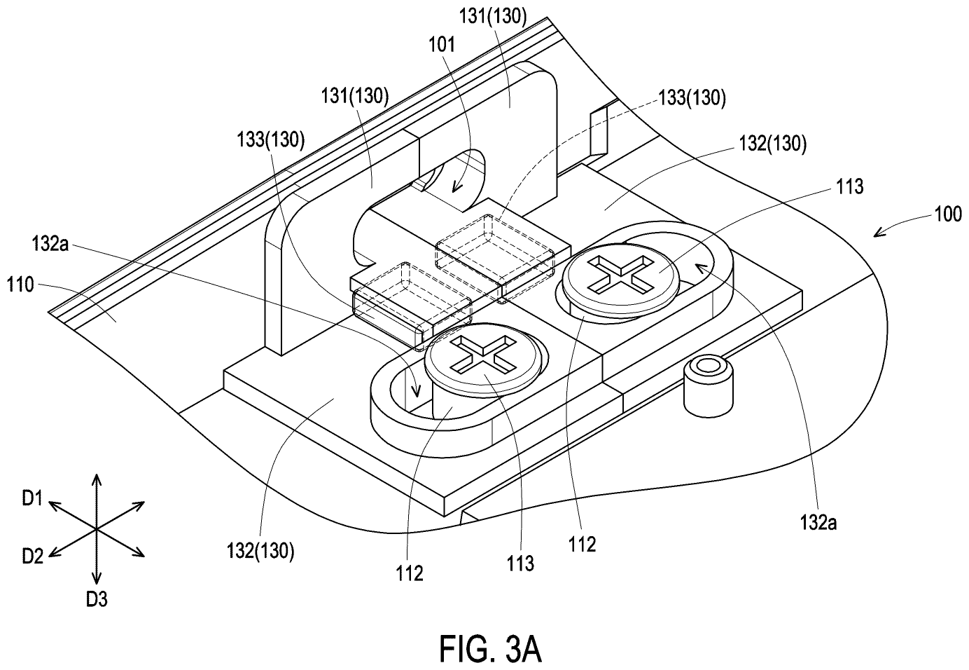

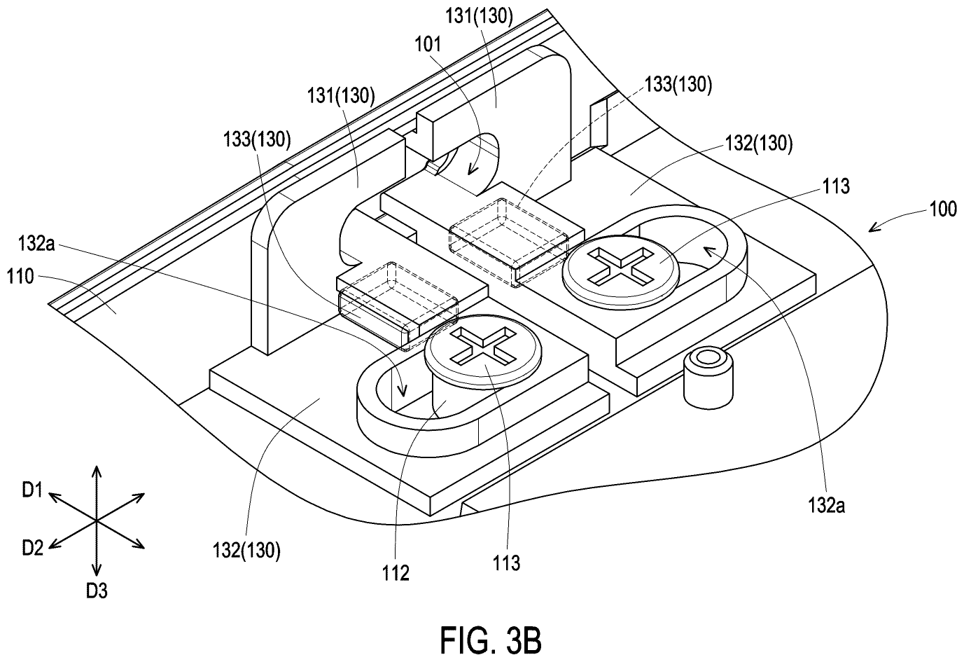

FIG. 3A and FIG. 3B are schematic diagrams of FIG. 1A and FIG. 1B from other perspectives respectively, and the male connector 10 and the female connector 120 are omitted. Please refer to FIG. 1A, FIG. 1B, FIG. 3A and FIG. 3B, in the embodiment, each of the two guiding members 130 further includes a sliding part 132 located in the body 110 and connected to the corresponding guiding part 131. Specifically, two positioning parts 112 are provided inside the body 110, and the two sliding parts 132 are slidably sleeved on the two positioning parts 112 respectively. For example, the two positioning parts 112 may be two screw bosses, and two screws 113 are respectively fastened to the two screw bosses to produce a positioning effect on the two sliding parts 132 to prevent each of the two guiding members 130 from detaching from the corresponding positioning part 112 along the third direction D3, but do not affect the freedom of movement of each of the two guiding members 130 in sliding in the second direction D2.

As shown in FIG. 3A and FIG. 3B, the sliding part 132 of each of the two guiding members 130 has a sliding groove 132a parallel to the second direction D2, and the two positioning parts 112 respectively penetrate through the two sliding grooves 132a. Therefore, each of the two guiding members 130 can slide back and forth along the second direction D2 with the cooperation of the sliding groove 132a and the corresponding positioning part 112.

On the other hand, each of the two guiding members 130 further includes a magnetic part 133 fixed on the sliding part 132, and a magnetic attraction force is generated between the two magnetic parts 133. For example, the two magnetic parts 133 may be a combination of two magnets or a combination of a magnet and a magnetic attracted member.

Please refer to FIG. 1A, FIG. 1B, FIG. 3A and FIG. 3B, before the male connector 10 is inserted into the lateral opening 111, the two guiding parts 131 are in contact, and the magnetic attraction generated between the two magnetic parts 133 can cause the two guiding parts 131 keep in contact and prevent each of the two guiding parts 131 from accidentally sliding in the body 110.

When the male connector 10 is inserted into the lateral opening 111 along the first direction D1, the male connector 10 contacts the two guiding parts 131 and pushes the two guiding parts 131 to slide away from each other along the second direction D2. After the male connector 10 is plugged into the female connector 120, the magnetic attraction force generated between the two magnetic parts 133 can drive each of the two guiding parts 131 to abut against the male connector 10, so that the male connector 10 is clamped and positioned between the two guiding parts 131. Once the male connector 10 is unplugged from the female connector 120 and moved out of the lateral opening 111, the magnetic attraction generated between the two magnetic parts 133 can drive the two guiding members 130 to slide close to each other and thus the two guiding parts 131 are in contact.

In summary of the foregoing, in the electronic device of the disclosure, the body is provided with two guiding members at the lateral opening. When the male connector is inserted into the lateral opening, the male connector contacts the two guiding members. In detail, the male connector can be buffered and guided by the two guiding members to decrease the inserting speed and force and align the male connector with the female connector to smoothly plug into the female connector, and thus preventing the male connector from colliding with the female connector due to misalignment and helping to reduce the chance of damage to the female connector to elongate the service life thereof.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An electronic device suitable for connection with a male connector, comprising:
a body having a lateral opening;
a female connector disposed in the body as corresponding to the lateral opening, wherein the male connector is adapted to be inserted into the lateral opening along the first direction and plugged into the female connector; and
two guiding members disposed in the body as corresponding to the lateral opening and are adapted to slide along a second direction perpendicular to the first direction, each of the two guiding members comprises a guiding part located in the lateral opening, and the two guiding parts encircle to form a movable opening,
when the male connector is inserted into the lateral opening, the male connector contacts the two guiding parts and pushes the two guiding parts to slide away from each other, and thus the movable opening expands from a first opening area to a second opening area.

2. The electronic device according to claim 1, wherein the movable opening has the first opening area when the two guiding parts are in contact, and the movable opening has the second opening area when the two guiding parts are separated from each other.

3. The electronic device according to claim 1, wherein each of the two guiding parts has a recessed opening, and the two recessed openings face each other to define the movable opening.

4. The electronic device according to claim 3, wherein each of the two guiding parts further has a guiding bevel surrounding the recessed opening.

5. The electronic device according to claim 1, wherein the female connector has a connector opening for the male connector inserting thereto, and the connector opening has a first inner diameter in the second direction, the movable opening has a second inner diameter in the second direction when the two guiding parts are in contact, and the second inner diameter is smaller than the first inner diameter, the movable opening has a third inner diameter in the second direction when the two guiding parts are separated from each other, and the third inner diameter is greater than the first inner diameter.

6. The electronic device according to claim 5, wherein in a third direction perpendicular to the first direction and the second direction, the connector opening has a fourth inner diameter, and the movable opening has a fifth inner diameter greater than the fourth inner diameter.

7. The electronic device according to claim 1, wherein each of the two guiding members further comprises a sliding part located in the body and connected to the corresponding guiding part, two positioning parts are provided inside the body, and the two sliding parts are slidably sleeved on the two positioning parts respectively.

8. The electronic device according to claim 7, wherein the sliding part of each of the two guiding members has a sliding groove parallel to the second direction, and the two positioning parts respectively penetrate through the two slide grooves.

9. The electronic device according to claim 7, wherein each of the two guiding members further comprises a magnetic part fixed on the sliding part, and a magnetic attraction force is generated between the two magnetic parts.

10. The electronic device according to claim 1, wherein the two guiding members are arranged in symmetry.
